(19) United States
(12) Patent Application Publication
(10) Pub. No.: US 2024/0263722 A1
(43) Pub. Date: Aug. 8, 2024

(54) MULTILAYER POLYARYLENE SULFIDE TUBES

(71) Applicant: Solvay Specialty Polymers USA, LLC, Alpharetta, GA (US)

(72) Inventors: Gaetano CALVARUSO, Pforzheim (DE); Gregory C. PLITHIDES, Los Gatos, CA (US); Marc SCHELLES, GEEL (BE); William E. SATTICH, Cumming, GA (US)

(21) Appl. No.: 18/565,637

(22) PCT Filed: Jun. 9, 2021
(86) PCT No.: PCT/EP2021/065501

§ 371 Date: Nov. 30, 2023

(51) Int. Cl. F16L 9/12; B29C 48/09; B29C 48/21; B29K 81/00; B29K 105/16; B29K 507/04; B29L 23/00; B32B 1/08; B32B 27/08; B32B 27/18; B32B 27/28; C08K 3/04; C08L 81/02; H05F 3/00

(52) U.S. Cl. CPC F16L 9/125; B32B 1/08; B32B 27/08; B32B 27/18; B32B 27/286; C08K 3/041; C08L 81/02; F16L 9/121; H05F 3/00; B29C 48/09; B29C 48/21; B29K 2081/00; B29K 2105/162; B29K 2507/04; B29K 2995/0005; B29L 2023/22; B32B 2250/24; B32B 2264/025; B32B 2264/108; B32B 2307/202; B32B 2307/558; B32B 2307/7376; B32B 2597/00; C08K 2201/001; C08K 2201/011; C08L 2203/18

(57) ABSTRACT

Described here are multilayer tubes including a plurality of layers. The multilayer tubes include an outermost layer, including a first polyarylene sulfide (“PAS”) and from 5 wt. % to 30 wt. % of an impact modifier. The multilayer tubes also include an innermost layer including a second PAS and from 0.1 wt. % to 10 wt. % of an electrically conductive filler. Significantly, each layer in the multilayer tube comprises a PAS. The outermost layer is the sole layer comprising an impact modifier and the innermost layer is the sole layer comprising an electrically conductive filler. At least in part because of compatibility of PAS based materials with one another for interfacial bonding, the multilayer tube is free of tie layers.

### FIELD OF THE INVENTION

The invention relates to multilayer tubing including an innermost layer and an outermost layer, the layers including polyarylene sulfides (“PAS”), having desirable resistance to fuel solvation and fuel permeation and desirable electrostatic charge dissipation. The invention further relates to the aforementioned multilayer tubing including an intermediate layer, also including a PAS.

### BACKGROUND OF THE INVENTION

Current non-metal automotive fuel line tubing typically has multiple layers including a thicker primary tube which is the main structural component and formed from PA11 or PA12, and thinner layers of other polymeric layers to achieve desirable resistance to fuel solvation and fuel permeation and to provide electrostatic charge dissipation (“ESD”) capability. Due to interfacial bonding incompatibility between the different layers, owing to their different compositions, intervening “tie layers” are incorporated to sufficiently bond together the layers of the different materials to prevent delamination of the multilayer structure. Nevertheless, increasing the number of layers in a tube results in increased production complexity and cost.

### SUMMARY OF INVENTION

In a first aspect, the invention is directed to a multilayer tube comprising a plurality of layers and including: an outermost layer comprising: a first polyarylene sulfide (“PAS”) and 0 wt. % to 40 wt. % of an impact modifier, and an innermost layer comprising: a second PAS and 0.1 wt. % to 5 wt. % of an electrically conductive filler. Each layer in the multilayer tube comprises a PAS. Furthermore, the outermost layer is the sole layer comprising an impact modifier and the innermost layer is the sole layer comprising an electrically conductive filler. In some embodiments, the first PAS and the second PAS are independently represented by the following formula (1):

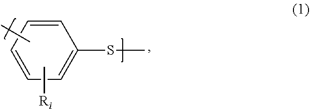

wherein, R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group and i is an independently selected integer from 0 to 4; and j, at each instance, is an independently selected integer from 0 to 3. In some embodiments, the first PAS is the same as the second PAS. In some embodiments, the outermost layer consists essentially of the first PAS and the 10 wt. % to 40 wt. % of any impact modifier. In some embodiments, the innermost layer consists essentially of the second PAS and the 0.1 wt. % o 5 wt. % or an electrically conductive filler. In some embodiments, the outermost layer and the innermost layer are the sole layers. In some embodiments, the outermost layer has a thickness of from 0.1 mm to no more than 10 mm and the inner most layer has a thickness of from 10 μm to no more than 1500 μm.

In some embodiments, the multilayer tube further comprises an intermediate layer in contact with the outermost layer and innermost layer, the intermediate layer including a third PAS. In some embodiments, the third PAS is independently represented by formula (1). In some embodiments, the first PAS, the second PAS and the third PAS are the same. In some embodiments, the intermediate layer consists essentially of the third PAS. In some embodiments,

the intermediate layer has a thickness of from 10 μm to no more than 1500 μm.

In some embodiments, the impact modifier is an ethylene/methyl acrylate/glycidyl methacrylate copolymer. In some embodiments, the electrically conductive filler is carbon nanotubes, preferably single-walled carbon nanotubes.

In another aspect, the invention is directed to a method of forming the multilayer tube the method comprising co-extruding the outermost layer, the innermost layer and, if present, the intermediate layer to form the multilayer tube.

### BRIEF DESCRIPTION OF THE DRAWINGS

FIG. 1 is a schematic depiction of a multilayer tube having, as sole layers, an outermost layer and an innermost layer as the sole layers.

FIG. 2 is a schematic depiction of a multilayer tube having, as sole layers, an outermost layer, an innermost layer, and an intermediate layer disposed between and contacting the outermost layer and the innermost layer.

### DETAILED DESCRIPTION OF THE INVENTION

Described here are multilayer tubes including a plurality of layers. The multilayer tubes include an outermost layer, including a first polyarylene sulfide (“PAS”) and from 5 wt. % to 30 wt. % of an impact modifier. The multilayer tubes also include an innermost layer including a second PAS and from 0.1 wt. % to 10 wt. % of an electrically conductive filler. Significantly, each layer in the multilayer tube comprises a PAS, while the outermost layer and innermost layer are free of an electrically conductive filler and impact modifier. More particularly, the outermost layer is the sole layer comprising an impact modifier and the innermost layer is the sole layer comprising an electrically conductive filler. At least in part because of the compatibility of PAS based materials with one another for interfacial bonding, the multilayer tube is free of tie layers. Accordingly, the multilayer tubes described herein have a reduced number of layers, relative to traditional non-metal automotive fuel line tubes and, therefore, have significantly reduced manufacturing complexity. Furthermore, because of the inherent fuel solvation and permeation resistance of PAS, as well as its desirable mechanical performance, the multilayer tubes having only PAS based layers can achieve desired performance characteristics (e.g. resistance to fuel solvation and fuel permeation and to provide electrostatic charge dissipation (“ESD”) capability) for automotive tubing while using fewer layers. As used herein, wt. % is relative to the total weight of the indicated layer, unless explicitly noted otherwise.

In the present application, any description, even though described in relation to a specific embodiment, is applicable to and interchangeable with other embodiments of the present disclosure. Where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and any recitation herein of numerical ranges by endpoints includes all numbers subsumed within the recited ranges as well as the endpoints of the range and equivalents.

Unless specifically limited otherwise, the term “alkyl”, as well as derivative terms such as “alkoxy”, “acyl” and “alkylthio”, as used herein, include within their scope straight chain, branched chain and cyclic moieties. Examples of alkyl groups are methyl, ethyl, 1-methylethyl, propyl, 1,1-dimethylethyl, and cyclo-propyl. Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of a cycloaromatic group and two C₁-C₆ groups (e.g. methyl or ethyl). The aryl group may also comprise one or more heteroatoms, e.g. N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

### The Polyarylene Sulfide

Each layer in the multilayer tube comprises a PAS. The PAS includes at least 50 mol % of a recurring unit (R_{PAS}) having at least one aromatic ring bonded to a sulfur atom. In some embodiment, the concentration of recurring unit (R_{PAS}) is at least 60 mol %, at least 70 mol %, at least 80 mol %, at least 90 mol %, at least 95 mol %, at least 97 mol %, at least 98 mol %, at least 99 mol % or at least 99.9 mol %. As used herein, mol % is relative to the total number of recurring units in the indicated polymer (e.g. PAS), unless explicitly noted otherwise.

In some embodiments, recurring unit (R_{PAS}) is represented by a formula selected from the following group of formulae:

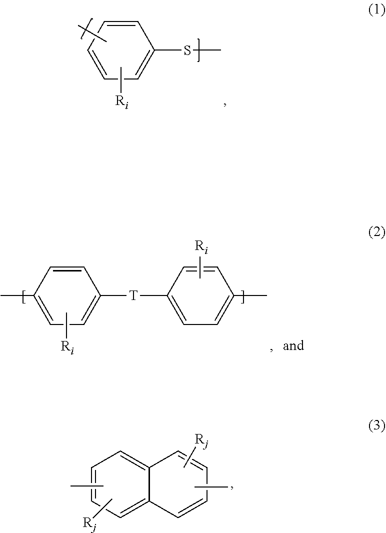

where, R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group; T is selected from the group consisting of a bond, —CO—, —SO₂—, —O—, —C(CH₃)₂, phenyl and —CH₂—; i, at each instance, is an independently selected integer from 0 to 4; and j, at each instance, is an independently selected integer from 0 to 3. For clarity, when i or j is zero, the corresponding benzyl rings are unsubstituted; similar notation is used throughout. Preferably, the PAS is a polyphenylene sulfide (“PPS”), namely, where recurring unit (R_{PAS}) is represented by formula (1). More preferably, recurring unit (R_{PAS}) is represented by the following formula:

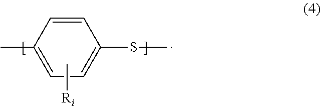

Most preferably, recurring unit (R_{PAS}) is represented by formula (4).

The PAS can be amorphous or semi-crystalline. As used herein, an amorphous polymer has an enthalpy of fusion (“ΔH_{f}”) of no more than 5 Joules/g (“J/g”). The person of ordinary skill in the art will recognize that when the PAS is amorphous, it lacks a detectable Tₘ. Accordingly, where a PAS polymer has a Tm, the person of ordinary skill in the art will recognize that it refers to semi-crystalline polymer. Preferably, the PAS polymer is semi-crystalline. In some embodiments, the PAS polymer has a ΔH_{f} of at least 10 J/g, at least 20 J/g, at least, or at least 25 J/g. In some embodiments, the PAS polymer has a ΔH_{f} of no more than 90 J/g, no more than 70 J/g or no more than 60 J/g. In some embodiments, the PAS polymer has a ΔH_{f} of from 10 J/g to 90 J/g or from 20 J/g to 70 J/g. ΔH_{f} can be measured using differential scanning calorimetry (“DSC”), according to ASTM D3418 employing a heating and cooling rate of 20° C./min. Advantageously, three scans are used for each DSC test: a first heat up to 350° C., followed by a first cool down to 30° C., followed by a second heat up to 350° C.

Preferably, the PAS has a melt flow rate (at 315.6° C. under a weight of 5 kg measured as described in the Examples below) of at most 700 g/10 min, more preferably of at most 500 g/10 min. Preferably, the PA has a melt flow rate of at least 5 g/10 min, more preferably of at least 30 g/10 min, even more preferably at least 50 g/mol. The MFR can be measured on a extrusion plastometer at 315.6° C. using a weight of 5 kg and a 0.0825 inch×0.315 inch die after a 5 minute equilibration period (with units of g·(10 min)⁻¹).

As noted above, each layer of the multilayer tube includes a PAS. In some embodiments, each layer of the tube includes at least 10 wt. %, at least 30 wt. %, at least 40 wt. %, at least 50 wt. %, at least 55 wt. % or at least 60 wt. % of a PAS. In some embodiments, each layer of the tube, excluding the outermost layer, includes at least 70 wt. %, at least 80 wt. %, at least 85 wt. %, at least 90 wt. %, at least 95 wt. % or at least 99 wt. % of a PAS.

### The Impact Modifier

The multilayer tube includes an outermost layer including the first PAS polymer and 5 wt. % to 40 wt. % of an impact modifier. More particularly, the outermost layer is the sole layer in the multilayer tube that comprises and impact modifier. An impact modifier is generally a low Tg polymer, with a Tg for example below room temperature, below 0° C. or even below −25° C. As a result of its low Tg, the impact modifiers are typically elastomeric at room temperature. Impact modifiers can be functionalized polymer backbones.

The polymer backbone of the impact modifier can be selected from elastomeric backbones comprising polyethylenes and copolymers thereof, e.g. ethylene-butene; ethylene-octene; polypropylenes and copolymers thereof, polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the impact modifier is functionalized, the functionalization of the backbone can result from the copolymerization of monomers which include the functionalization or from the grafting of the polymer backbone with a further component.

Specific examples of functionalized impact modifiers are notably terpolymers of ethylene, acrylic ester and glycidyl methacrylate; terpolymers of ethylene, n-butyl acrylate and glycidyl methacrylate; copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride. In one embodiment, the impact modifier is an ethylene/methyl acrylate/glycidyl methacrylate copolymer.

The concentration of the impact modifier in the outermost layer is from 5 wt. % to 40 wt. %. In some embodiments, the concentration of the impact modifier in the outermost layer is from 10 wt. % to 40 wt. %, from 15 wt. % to 40 wt. %, from 10 wt. % to 30 wt. % or from 15 wt. % to 30 wt. %.

As noted above, the outermost layer is the sole layer of the multilayer tube that comprises an impact modifier. Put another way, the impact modifier concentration in each of the other layers in the multilayer tube is less than 1 wt. %, less than 0.5 wt. %, less than 0.1 wt. %, less than 0.05 wt. % or less than 0.01 wt. %.

### The Electrically Conductive Filler

The multilayer tube includes an innermost layer including the second PAS polymer and from 0.1 wt. % to 10 wt. % of an electrically conductive filler. More particularly, the innermost layer is the sole layer of the multilayer tube that comprises and electrically conducting filler. As used herein, an electrically conductive filler has a surface resistivity of no more than 10⁶Ω per square as measured according to ASTM D257. The electrically conductive filler provides for improved ESD of the layer in which it is incorporated (at least the innermost layer). Electrically conductive fillers include, but are not limited to, conductive carbon black, metal flakes, metal powders, metalized glass spheres, metalized glass fibers, metal fibers, metalized whiskers, carbon fibers (including metalized carbon fibers), carbon nanotubes, intrinsically conductive polymers or graphite fibrils. Preferably, the electrically conductive filler is carbon nanotubes. Nanotubes are an example of nanometer or molecular size materials. Carbon nanotubes can be single-walled carbon nanotubes (“SWNT”), multiwalled carbon nanotubes (“MWNT”) (which consist of nested SWNT) or a mixture thereof. Preferably, the carbon nanotubes are SWNT. Carbon nanotubes and ropes of carbon nanotubes (e.g. SWNT or MWNT and ropes of SWNT or MWNT) exhibit high mechanical strength, metallic conductivity, and high thermal conductivity. When incorporated into polymer compositions, the carbon nanotubes or ropes of carbon nanotube impart the polymer composition with improved strength, toughness, electrical conductivity, and thermal conductivity. Such properties are especially useful in polymeric structural applications where electrical conductivity is desired, for example, in the presently described multilayer tubes.

In some embodiments the carbon nanotubes have an average aspect ratio, defined as the length (“L”) over the diameter (“D”), of 100 or more. In some embodiments, the carbon nanotubes can have an average aspect ratio of 1000 or more. In some embodiments, the carbon nanotubes have an average diameter of 1 nanometers (“nm”) to 3.5 nm or 4 nm (roping). In some embodiments, the carbon nanotubes have an average length of at least 1 μm.

The concentration of the carbon nanotubes in the innermost layer is from 0.1 wt. % to 10 wt. %. In some embodiments, the concentration of the carbon nanotubes in the innermost layer is from 0.1 wt. % to 8 wt. %, from 0.1 wt. % to 7 wt. %, from 0.1 wt. % to 6 wt. % or from 0.1 wt. % to 5 wt. %.

As noted above, the innermost layer is the sole layer in the multilayer tube that comprises an electrically conductive filler. Put another way, the electrically conductive filler concentration in each of the other layers in the multilayer tube is less than 1 wt. %, less than 0.5 wt. %, less than 0.1 wt. %, less than 0.05 wt. % or less than 0.01 wt. %.

### Additives

In some embodiments, one or more of the multilayer tube layers include an additive, including but not limited to reinforcing fillers. Additives include, but are not limited to, plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants (both halogen-free and halogen containing flame retardants), nucleating agents, acid scavengers, antioxidants, surface adhesion enhancers, silane coupling agents, and other processing aids. As used herein, additives do not include impact modifiers (also known as tougheners) or electrically conductive fillers.

As noted above, the multilayer tubes are desirably incorporated into application settings in which they may be exposed to elevated temperatures or in which they transfer flammable liquids or gasses. Accordingly, in some embodiments, a flame retardant is desirably incorporated into one or more of the multilayer tube layers. Still further, for analogous reasons, the flame retardant is preferably a halogen-free flame retardant.

In some embodiments, the halogen-free flame retardant is an organophosphorous compound selected from the group consisting of phosphinic salts (phosphinates), diphosphinic salts (diphosphinates) and condensation products thereof. Preferably, the organophosphorous compound is selected from the group consisting of phosphinic salt (phosphinate) of the formula (I), a diphosphinic salt (diphosphinate) of the formula (II) and condensation products thereof:

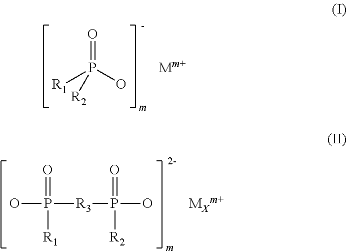

wherein, R₁, R₂ are identical or different and each of R₁ and R₂ is a hydrogen or a linear or branched C₁-C₆ alkyl group or an aryl group; R₃ is a linear or branched C₁-C₁₀ alkylene group, a C₆-C₁₀ arylene group, an alkyl-arylene group, or an aryl-alkylene group; M is selected from calcium ions, magnesium ions, aluminum ions, zinc ions, titanium ions, and combinations thereof, m is an integer of 2 or 3; n is an integer of 1 or 3; and x is an integer of 1 or 2.

Preferably, R₁ and R₂ are independently selected from methyl, ethyl, n-propyl, isopropyl, n-butyl, tert-butyl, n-pentyl, and phenyl; R3 is selected from methylene, ethylene, n-propylene, isopropylene, n-butylene, tert-butylene, n pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene, and phenylbutylene; and M is selected from aluminum and zinc ions.

Phosphinates are preferred as organophosphorous compound. Suitable phosphinates have been described in U.S. Pat. No. 6,365,071, incorporated herein by reference. Particularly preferred phosphinates are aluminum phosphinates, calcium phosphinates, and zinc phosphinates. Excellent results were obtained with aluminum phosphinates. Among aluminum phosphinates, aluminium ethylmethylphosphinate and aluminium diethylphosphinate and combinations thereof are preferred. Excellent results were in particular obtained when aluminium diethylphosphinate was used.

In some embodiments, the halogen-free flame retardant concentration in the layer of the multilayer tube is at least 5 wt. % or at least 7 wt. %. In some embodiments, the halogen-free flame retardant concentration in the layer of the multilayer tube is no more than 20 wt. % or no more than 15 wt. %. In some embodiments, the halogen-free flame retardant concentration in the layer of the multilayer tube is from 5 wt. % to 20 wt. %, from 7 wt. % to 20 wt. %, from 5 wt. % to 15 wt. % or from 7 wt. % to 15 wt. %.

In some embodiments, one or more of the multilayer tube includes an acid scavenger, most desirably in embodiments incorporating a halogen free flame retardant. Acid scavengers include, but are not limited to, silicone; silica; boehmite; metal oxides such as aluminum oxide, calcium oxide iron oxide, titanium oxide, manganese oxide, magnesium oxide, zirconium oxide, zinc oxide, molybdenum oxide, cobalt oxide, bismuth oxide, chromium oxide, tin oxide, antimony oxide, nickel oxide, copper oxide and tungsten oxide; metal powder such as aluminum, iron, titanium, manganese, zinc, molybdenum, cobalt, bismuth, chromium, tin, antimony, nickel, copper and tungsten; and metal salts such as barium metaborate, zinc carbonate, magnesium carbonate, calcium carbonate, and barium carbonate. In some embodiments, in which a layer of the multilayer tubes includes an acid scavenger, the acid scavenger concentration is from 0.01 wt. % to 5 wt. %, from 0.05 wt. % to 4 wt. %, from 0.08 wt. % to 3 wt. %, from 0.1 wt. % to 2 wt. %, from 0.1 wt. % to 1 wt. %, from 0.1 wt. % to 0.5 wt. % or from 0.1 wt. % to 0.3 wt. %.

In some embodiments, the total additive concentration in a layer is at least 0.1 wt. %, at least 0.2 wt. % or at least 0.3 wt. %. In some embodiments, the total additive concentration in a layer is no more than 20 wt. %, no more than 15 wt. %, no more than 10 wt. %, no more than 7 wt. % or no more than 5 wt. %. In some embodiments, the total additive concentration in a layer is from 0.1 wt. % to 20 wt. %, from 0.1 wt. % to 15 wt. %, from 0.1 wt. % to 10 wt. %, from 0.2 wt. % to 7 wt. % or from 0.3 wt. to 5 wt. %.

In some embodiments, one or more of the layers of the multilayer tube includes a reinforcing agent. A large selection of reinforcing agents, also called reinforcing fibers or fillers, may be added to the polymer composition (PC). In some embodiments, the reinforcing agent is selected from mineral fillers (including, but not limited to, talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers and wollastonite. Notably, as used herein, with reference to the innermost layer, a reinforcing agent does not include carbon nanotubes.

In general, reinforcing agents are fibrous reinforcing agents or particulate reinforcing agents. A fibrous reinforcing agent refers to a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. In some embodiments, the fibrous reinforcing agent (e.g. glass fibers or carbon fibers) has an average length of from 3 mm to 50 mm. In some such embodiments, the fibrous reinforcing agent has an average length of from 3 mm to 10 mm, from 3 mm to 8 mm, from 3 mm to 6 mm, or from 3 mm to 5 mm. In alternative embodiments, fibrous reinforcing agent has an average length of from 10 mm to 50 mm, from 10 mm to 45 mm, from 10 mm to 35 mm, from 10 mm to 30 mm, from 10 mm to 25 mm or from 15 mm to 25 mm. The average length of the fibrous reinforcing agent can be taken as the average length of the fibrous reinforcing agent prior to incorporation into the polymer composition (PC) or can be taken as the average length of the fibrous reinforcing agent in the polymer composition (PC).

With respect to glass fibers, they are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. The glass fibers can be added as endless fibers or as chopped glass fibers. The glass fibers have generally an equivalent diameter of 5 to 20 preferably of 5 to 15 μm and more preferably of 5 to 10 μm. All glass fiber types, such as A, C, D, E, M, S, R, T glass fibers (as described in chapter 5.2.3, pages 43-48 of Additives for Plastics Handbook, 2nd ed, John Murphy), or any mixtures thereof or mixtures thereof may be used.

E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, those glass fibers comprise typically from 62-75 wt. % of SiO2, from 16-28 wt. % of Al₂O₃ and from 5-14 wt. % of MgO. On the other hand, R, S and T glass fibers comprise less than 10 wt. % of CaO.

In some embodiments, the glass fiber is a high modulus glass fiber. High modulus glass fibers have an elastic modulus of at least 76, preferably at least 78, more preferably at least 80, and most preferably at least 82 GPa as measured according to ASTM D2343. Examples of high modulus glass fibers include, but are not limited to, S, R, and T glass fibers. A commercially available source of high modulus glass fibers is S-1 and S-2 glass fibers from Taishan and AGY, respectively.

The morphology of the glass fiber is not particularly limited. As noted above, the glass fiber can have a circular cross-section (“round glass fiber”) or a non-circular cross-section (“flat glass fiber”). Examples of suitable flat glass fibers include, but are not limited to, glass fibers having oval, elliptical and rectangular cross sections. In some embodiments in which the polymer composition includes a flat glass fiber, the flat glass fiber has a cross-sectional longest diameter of at least 15 μm, preferably at least 20 μm, more preferably at least 22 μm, still more preferably at least 25 μm. Additionally or alternatively, in some embodiments, the flat glass fiber has a cross-sectional longest diameter of at most 40 μm, preferably at most 35 μm, more preferably at most 32 μm, still more preferably at most 30 μm. In some embodiments, the flat glass fiber has a cross-sectional diameter was in the range of 15 to 35 μm, preferably of 20 to 30 μm and more preferably of 25 to 29 μm. In some embodiments, the flat glass fiber has a cross-sectional shortest diameter of at least 4 μm, preferably at least 5 μm, more preferably at least 6 μm, still more preferably at least 7 μm. Additionally or alternatively, in some embodiments, the flat glass fiber has a cross-sectional shortest diameter of at most 25 μm, preferably at most 20 μm, more preferably at most 17 μm, still more preferably at most 15 μm. In some embodiments, the flat glass fiber has a cross-sectional shortest diameter was in the range of 5 to 20 preferably of 5 to 15 μm and more preferably of 7 to 11 μm.

In some embodiments, the flat glass fiber has an aspect ratio of at least 2, preferably at least 2.2, more preferably at least 2.4, still more preferably at least 3. The aspect ratio is defined as a ratio of the longest diameter in the cross-section of the glass fiber to the shortest diameter in the same cross-section. Additionally or alternatively, in some embodiments, the flat glass fiber has an aspect ratio of at most 8, preferably at most 6, more preferably of at most 4. In some embodiments, the flat glass fiber has an aspect ratio of from 2 to 6, and preferably, from 2.2 to 4. In some embodiments, in which the glass fiber is a round glass fiber, the glass fiber has an aspect ratio of less than 2, preferably less than 1.5, more preferably less than 1.2, even more preferably less than 1.1, most preferably, less than 1.05. Of course, the person of ordinary skill in the art will understand that regardless of the morphology of the glass fiber (e.g. round or flat), the aspect ratio cannot, by definition, be less than 1.

In some embodiments, one or more layers of the multilayer tube includes a carbon fiber. In some embodiments, the carbon fiber is a polyacrylonitrile (“PAN”) based carbon fiber or a pitch (a viscoelastic material composed of aromatic hydrocarbons) based carbon fiber. In some embodiments, the carbon fiber is a standard modulus carbon fiber or an intermediate modulus carbon fiber. Standard modulus carbon fibers have a tensile modulus of from 227 GPa to 235 GPa. Intermediate modulus carbon fibers have a tensile modulus of from 282 GPA to 289 GPa. The carbon fiber can be a virgin carbon fiber or a recycled (post-consumer or post-industrial) carbon fiber (pyrolyzed or over-sized). In some embodiments, the carbon fiber has an average length of at least 1 mm, at least 3 mm, at least 4 mm, at least 5 mm or at least 6 mm. In some embodiments, the glass fiber has an average length of no more than 10 mm. In some embodiments, the carbon fiber has an average length of from 1 mm to 10 mm, from 3 mm to 10 mm, from 4 mm to 10 mm, from 5 mm to 10 mm or more 6 mm to 10 mm.

In some embodiments, the reinforcing agent (e.g. glass or carbon fibers) concentration in in a multilayer tube layer is at least at least 10 wt. %, at least 15 wt. % or at least 20 wt. %. In some embodiments, the reinforcing agent concentration in a multilayer tube layer is no more 70 wt. %, no more than 60 wt. % or no more than 50 wt. %. In some embodiments, the reinforcing agent concentration in the multilayer tube layer is from 10 wt. % to 70 wt. %, from 15 wt. % to 70 wt. % from 20 wt. % to 70 wt. %, from 10 wt. % to 60 wt. %, from 15 wt. % to 60 wt. %, from 20 wt. % to 60 wt. %, from 10 wt. % to 50 wt. %, from 15 wt. % to 50 wt. % or from or from 20 wt. % to 50 wt. %. In some embodiments in which a multilayer tube layers includes carbon fiber and glass fiber, the total concentration of carbon fiber and glass fiber is within the aforementioned ranges. In alternative such embodiments, the carbon fiber concentration and glass fiber concentration are each, independently within the ranges above.

In some embodiments in which the polymer composition (PC) includes carbon fiber and glass fiber, the weight ratio of the carbon fiber to glass fiber (weight of carbon fiber in the polymer composition (PC)/weight of glass fiber in the polymer composition (PC)) is at least 0.05, at least 0.15, at least 0.2, at least 0.5, at least 0.75, or at least 1. In some embodiments in which the polymer composition (PC) includes carbon fiber and glass fiber, the weight ratio of the carbon fiber to the glass fiber is no more than 4, no more than 3, no more than 2 or no more than 1. In some embodiments, in which the polymer composition (PC) includes carbon fiber and glass fiber, the weight ratio of the carbon fiber to the glass fiber is from 0.05 to 4, from 0.05 to 3, from 0.05 to 2, from 0.05 to 1, from 0.15 to 4, from 0.15 to 3, from 0.15 to 2, from 0.15 to 1, from 0.2 to 5, from 0.2 to 4, from 0.2 to 3, from 0.2 to 1, from 0.5 to 4, from 0.5 to 3, from 0.5 to 2 from 0.5 to 1, from 1 to 4, from 1 to 3 or from 1 to 2.

### The Multilayer Tube

The multilayer tube includes the outermost layer and the innermost layer. The multilayer tube is generally cylindrical. The outermost layer (layer with largest inner and outer diameters) is the external layer of the multilayer tube, meaning there are no layers beyond the outermost layer. For example, the outer surface of the outermost layer is not in contact with any other layer of the multilayer tube. Put another way, the outermost layer is in contact with the external environment of the multilayer tube. Similarly, the inner surface of the innermost layer (layer with the smallest inner diameter and outer diameter) in not in contact with any other layer of the multilayer tube. Put another way, the innermost layer is the layer in contact with the fluid or gas that is transported by the multilayer tube during its intended use (notwithstanding vapour diffusion, of course).

In some embodiments, the PAS of each layer is distinct from each other layer. In some embodiments, the PAS of at least one layer is the same as the PAS of another layer and the remainder of the layers have a distinct PAS. In some embodiments, the PAS of each of the layers is the same.

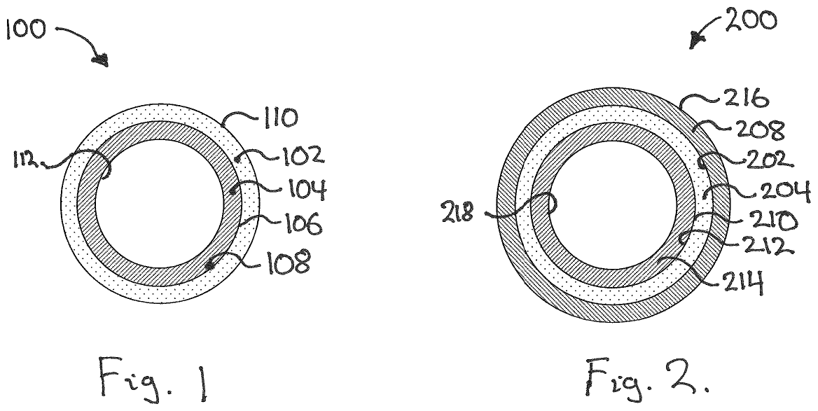

In some embodiments, the multilayer tube includes the outermost layer and the innermost layer as the sole layers. FIG. 1 is a schematic depiction of a multilayer tube having an outermost layer and an innermost layer as the sole layers. Referring to FIG. 1, in multilayer tube 100, outermost layer 102 and innermost layer 104 are in contact with each other, for example, throughout the length of the tube. Inner surface 106 of the outermost layer 102 is in contact with the outer surface 108 of the innermost layer 104. Outer surface 110 of outermost layer 102 is exposed to the external environment of multilayer tube 100 and inner surface 112 of innermost layer 104 is in contact with the fuel or gas being transported by multilayer tube 100. In some embodiments, outermost layer 102 comprises, or consists essentially of, the first PPS and the from 10 wt. % to 40 wt. % of an impact modifier. In some embodiments, innermost layer 104 comprises, or consists essentially of, the second PPS and the from 0.1 wt. % to 5 wt. % of an electrically conductive filler. In some embodiments, outermost layer 102 consists essentially of the first PAS and the from 10 wt. % to 40 wt. % of an impact modifier and innermost layer 104 consists essentially of the second PAS and the from 0.1 wt. % to 5 wt. % of an electrically conductive filler. In some embodiments in which the multilayer tube includes outermost layer 102 and innermost layer 104 as the sole layers, the first PAS is the same as the second PAS. Preferably, the first PAS and the second PAS include recurring unit (R_{PAS}) independently represented by formula (1), most preferably the first PAS and the second PAS include recurring unit (R_{PAS}) represented by formula (2). Preferably the electrically conductive filler is carbon nanotubes. As used herein “consists essentially” with respect to a layer means that the total concentration of components (e.g. additives) not explicitly recited is less than 1 wt. %, less 0.5 wt. %, less than 0.1 wt. %, less than 0.05 wt. % or less than 0.01 wt. %.

In some embodiments, the multilayer tube includes, as sole layers, the outermost layer, the innermost layer, and an intermediate layer disposed between and contacting the outermost layer and the innermost layer. FIG. 2 is a schematic depiction of a multilayer tube, having, as sole layers, an outermost layer, an innermost layer, and an intermediate layer disposed between and contacting the outermost layer and the innermost layer. Referring to FIG. 2, in multilayer tube 200, outer surface 202 of intermediate layer 204 is in contact with the inner surface 206 of outermost layer 208 and, furthermore, inner surface 210 of the intermediate layer 204 is in contact with outer surface 212 of innermost layer 214. Outer surface 216 of outermost layer 208 is exposed to the external environment of multilayer tube 200 and inner surface 218 of innermost layer 214 is in contact with the fuel or gas being transported by multilayer tube 200. Intermediate layer 204 includes a third PAS. In some embodiments, outermost layer 208 comprises, or consists essentially of, the first PPS and the from 10 wt. % to 40 wt. % of the an impact modifier. In some embodiments, innermost layer 214 comprises, or consists essentially of, the second PPS and the from 0.1 wt. % to 5 wt. % of an electrically conductive filler. In some embodiments, intermediate layer 204 comprises, or consists essentially of, the third PAS. In some embodiments, outermost layer 208 consists essentially of, the first PPS and the from 10 wt. % to 40 wt. % of the an impact modifier; innermost layer 214 consists essentially of the second PPS and the from 0.1 wt. % to 5 wt. % of an electrically conductive filler; and intermediate layer 204 consists essentially of the third PAS. In some embodiments, the first PAS, second PAS and third PAS are all distinct PAS. In some embodiments, the first PAS and the second PAS are the same, and the third PAS is distinct. In some embodiments, the first PAS, the second PAS and the third PAS are all the same. Preferably, the first PAS, the second PAS and third PAS include recurring unit (R_{PAS}) independently represented by formula (1), most preferably the first PAS, the second PAS and third PAS include recurring unit (R_{PAS}) represented by formula (2). Preferably, the electrically conductive filler is carbon nanotubes.

In some embodiments, the outermost layer has a thickness of at least 0.1 mm, at least 0.5, at least 1 mm or at least 2 mm. In some embodiments, the outermost layer has a thickness of no more than 10 mm, no more than 5 mm or no more than 4 mm. In some embodiments, the outermost layer has a thickness of from 0.1 mm to no more than 10 mm, to no more than 5 mm or to no more than 4 mm. In some embodiments, the outermost layer has a thickness of from 0.5 mm to no more than 10 mm, to no more than 5 mm or to no more than 4 mm. In some embodiments, the outermost layer has a thickness of from 1 mm to no more than 10 mm, to no more than 5 mm or to no more than 4 mm. In some embodiments, the outermost layer has a thickness of from 2 mm to no more than 10 mm, to no more than 5 mm or to no more than 4 mm. In some embodiments, the innermost layer has a thickness of at least 10 micrometers (“μm”), at least 50 μm, at least 80 μm or at least 90 μm. In some embodiments, the innermost layer has a thickness of no more than 1500 μm, no more than 1000 μm, no more than 500 μm, no more than 300 μm, no more than 200 μm, no more than 150 μm or no more than 110 μm. In some embodiments, the innermost layer has a thickness of from 10 μm to 1500 μm, from 10 μm to 1000 μm, from 50 μm to 500 μm, from 50 μm to 300 μm, from 80 μm to 200 μm, from 90 μm to 150 μm or from 90 μm to 110 μm. In some embodiments, the innermost layer has a thickness of at least 10 micrometers (“μm”), at least 50 μm, at least 80 μm or at least 90 μm. In some embodiments, the intermediate layer has a thickness of no more than 1500 μm, no more than 1000 μm, no more than 500 μm, no more than 300 μm, no more than 200 μm, no more than 150 μm or no more than 110 μm. In some embodiments, the intermediate layer has a thickness of from 10 μm to 1500 μm, from 10 μm to 1000 μm, from 50 μm to 500 μm, from 50 μm to 300 μm, from 80 μm to 200 μm, from 90 μm to 150 μm or from 90 μm to 110 μm.

### Fabrication of Multilayer Tube

The multilayer tubes can be formed using methods well known in the art. One desirable method involves melt-blending the PASs, including additional layer components (e.g. additives and reinforcing fillers) and co-extruding the multilayer tube.

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, long fibers as well as continuous fibers), drawing extrusion or pultrusion may be used to prepare a reinforced composition. The melt-blended polymers can be co-extruded to form the multilayer tubes.

### EXAMPLES

This example demonstrates the mechanical strength and fuel permeation performance of the multilayer tubes described herein.

Tests were conducted on a multilayer tube having a 15.5 mm outer diameter and a total thickness of 1.75 mm. The tube had three layers with the following dimensions: a 1.19 mm thick outermost layer, a 0.25 mm thick intermediate layer, and a 0.34 mm thick innermost layer. The outermost layer consisted of 75 wt. % PPS and 25 wt. % of a reactive impact modifier. The intermediate layer consisted of PPS. The innermost layer consisted of 76 wt. % PPS, 16 wt. % of round E-glass fiber, 5 wt. % of a reactive impact modifier (distinct from the reactive impact modifier of the outermost layer), 1 wt. % of carbon black (electrically conductive filler) and <2% of thermal stabilizers and lubricants

The mechanical strength of the multilayer tubes was measured as follows. Burst pressure tests were performed according to DIN 73411-2. The tubes were cut into lengths of approximately 20 cm, which were closed by metal end-load resistant mechanical fittings. The assembled tubes were filled with water and the air was purged. The pressure in the assemblies was increased at a rate of approximately 34 bar/min until pipe burst occurred. The tube had a burst pressure value of 96.9 bar, which was similar to a monolayer tube having the same composition as the outermost layer and having an outer diameter 16 mm and thickness 1.5 mm (“control tube”). This control tube has a burst pressure value of 97.3 bar.

Fuel permeation was measured as follows. A multilayer tube as described above was cut into two sections, each having a length of 20 cm. Each section was then closed by metal end-load resistant mechanical fittings. One assembled section was filled with 13 ml CE10 and the other with 13 ml of CM15. The filled sections were placed in an oven at 40° C. for 30 days. The difference in weight before and after heating in the oven corresponded to permeated fuel. The fuel permeation was calculated as:

$$\frac{( {W}_{i} - {W}_{f} ) T}{At}$$

where Wᵢ and W_{f} are the initial (before heating) and final (after heating) weights of the tube section, respectively; T is the total thickness of the tube section, A is the inner surface area of the tube section; and t is the time heating time. The fuel permeation was 0.65 (g·mm)/(m²·days) and 0.21 (g·mm)/(m²·days) for the tube section filled with CE10 fuel and CM15 fuel, respectively. Running the same tests on two sections of the control tube, the fuel permeation was found to be 15.6 (g·mm)/(m²·days) and 6.9 (g·mm)/(m²·days) for CE10 and CM15 fuels, respectively.

The embodiments above are intended to be illustrative and not limiting. Additional embodiments are within the inventive concepts. In addition, although the present invention is described with reference to particular embodiments, those skilled in the art will recognized that changes can be made in form and detail without departing from the spirit and scope of the invention. Any incorporation by reference of documents above is limited such that no subject matter is incorporated that is contrary to the explicit disclosure herein.

1. A multilayer tube comprising a plurality of layers and including:
an outermost layer comprising:
a first polyarylene sulfide (“PAS”) and
10 wt. % to 40 wt. % of an impact modifier, and
an innermost layer comprising:
a second PAS and
0.1 wt. % to 5 wt. % of an electrically conductive filler,
wherein
each layer in the multilayer tube comprises a PAS;
the outermost layer is the sole layer comprising an impact modifier; and
the innermost layer is the sole layer comprising an electrically conductive filler.

2. The multilayer tube of claim 1, wherein the first PAS and the second PAS are independently represented by the following formula (1): 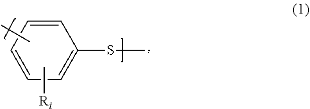
wherein, R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group and i is an independently selected integer from 0 to 4; and j, at each instance, is an independently selected integer from 0 to 3.

3. The multilayer tube of claim 1, wherein the first PAS is the same as the second PAS.

4. The multilayer tube of claim 1, wherein the outermost layer consists essentially of the first PAS and the 10 wt. % to 40 wt. % of the impact modifier.

5. The multilayer tube of claim 1, wherein the innermost layer consists essentially of the second PAS and the 0.1 wt. % to 5 wt. % or an electrically conductive filler.

6. The multilayer tube of claim 1, wherein the outermost layer and the innermost layer are the sole layers.

7. The multilayer tube of claim 1, wherein the outermost layer has a thickness of from 0.1 mm to no more than 10 mm and the inner most layer has a thickness of from 10 μm to no more than 1500 μm.

8. The multilayer tube of claim 1, further comprising an intermediate layer in contact with the outermost layer and innermost layer, the intermediate layer comprising a third PAS.

9. The multilayer tube of claim 8, wherein the third PAS is independently represented by formula (1).

10. The multilayer tube of claim 8, wherein the first PAS, the second PAS and the third PAS are the same.

11. The multilayer tube of claim 8, wherein the intermediate layer consists essentially of the third PAS.

12. The multilayer tube of claim 8, wherein the intermediate layer has a thickness of from 10 μm to no more than 1500 μm.

13. The multilayer tube of claim 1, wherein the impact modifier is an ethylene/Methyl acrylate/glycidyl methacrylate copolymer.

14. The multilayer tube of claim 1, wherein the electrically conductive filler is carbon nanotubes, preferably, single-walled carbon nanotubes.

15. A method of forming a multilayer tube comprising a plurality of layers and including:
an outermost layer comprising:
a first polyarylene sulfide (“PAS”) and
10 wt. % to 40 wt. % of an impact modifier, and
an innermost layer comprising:
a second PAS and
0.1 wt. % to 5 wt. % of an electrically conductive filler,
wherein
each layer in the multilayer tube comprises a PAS;
the outermost layer is the sole layer comprising an impact modifier; and
the innermost layer is the sole layer comprising an electrically conductive filler, the method comprising co-extruding the outermost layer and the innermost layer to form the multilayer tube.
